(19) United States
(12) Patent Application Publication
(10) Pub. No.: US 2021/0096356 A1
(43) Pub. Date: Apr. 1, 2021

(54) PHOSPHOR WHEEL

(71) Applicant: DELTA ELECTRONICS, INC., Taoyuan City (TW)

(72) Inventors: Meng-Sheng CHANG, Taoyuan City (TW); Hui-Hsiung WANG, Taoyuan City (TW)

(21) Appl. No.: 16/792,311

(22) Filed: Feb. 17, 2020

(30) Foreign Application Priority Data
Sep. 30, 2019 (CN) 201910941357.2

(51) Int. Cl. G02B 26/00; G03B 21/16

(52) U.S. Cl. CPC G02B 26/008; G03B 21/204; G03B 21/16

(57) ABSTRACT

A phosphor wheel includes a wheel body, a photoluminescence layer, and a plurality of blades. The photoluminescence layer is disposed on a front surface of the wheel body. The blades are disposed on a back surface of the wheel body, and a vertical projection of the photoluminescence layer on the wheel body at least partially overlaps vertical projections of the blades on the wheel body. The blades are located within some areas of the back surface of the wheel body and respectively extend along curved paths, and a straight line connecting from a symmetric center of the wheel body to an edge of the wheel body intersects more than one of the blades.

### RELATED APPLICATIONS

This application claims priority to China Application Serial Number 201910941357.2, filed Sep. 30, 2019, which is herein incorporated by reference.

### BACKGROUND

### Field of Invention

The present disclosure relates to a phosphor wheel, and more particularly, to a phosphor wheel with a heat dissipation function.

### Description of Related Art

The statements in this section merely provide background information related to the present disclosure and do not necessarily constitute prior art.

In recent years, projectors have been used in several fields, and application scope of projectors has expanded from consumer products to high-tech equipment. Various projectors have been widely used in schools, homes, and markets since projectors can enlarge patterns provided from a signal source and then display the patterns on projection screens.

In respect to configuration of light sources of projectors, laser light sources can be used to activate phosphor materials to emit light. To this, a motor can be used to drive a wheel coated with phosphor materials to rotate at high speed so that the phosphor materials receive less energy from the laser light sources per unit time, thereby achieving the purpose of heat dissipation. However, as the brightness requirements of projectors keep growing up, heat dissipation of phosphor materials become more and more critical.

Accordingly, how to provide a phosphor wheel and phosphor materials thereon to provide better solutions for heat dissipation becomes an important issue to be solved by those in the industry.

### SUMMARY

An aspect of the disclosure is to provide a phosphor wheel which can effectively solve the aforementioned problems.

According to the first embodiments of the present disclosure, a phosphor wheel includes a wheel body, a photoluminescence layer, and a plurality of blades. The photoluminescence layer is disposed on a front surface of the wheel body. The blades are disposed on a back surface of the wheel body, and a vertical projection of the photoluminescence layer on the wheel body at least partially overlaps vertical projections of the blades on the wheel body. The blades are located within some areas of the back surface of the wheel body and respectively extend along curved paths, and a straight line connecting from a symmetric center of the wheel body to an edge of the wheel body intersects more than one of the blades.

In some embodiments of the disclosure, each of the blades has a first end and a second end, the first end is farther from the symmetric center of the wheel body than the second end, and one line connecting from the symmetric center of the wheel body to the first end and one line connecting from the symmetric center of the second end form an angle, and the angle is from 20 degrees to 45 degrees.

In some embodiments of the disclosure, each of the blades has a first end and a second end, the first end is farther from the symmetric center of the wheel body than the second end, and a tangent line of the curved path passing through the first end and a tangent line of the edge of the wheel body passing through the first end form an angle smaller than 45 degrees.

In some embodiments of the disclosure, the phosphor wheel further comprises a carrier located between the wheel body and the photoluminescence layer and configured to be ring-shaped, wherein each of the blades has a first end and a second end, and the first end is farther from the symmetric center of the wheel body than the second end, wherein an interior edge of a vertical projection of the ring-shaped carrier on the wheel body is aligned with a vertical projection of the second end of each of the blades on the wheel body.

In some embodiments of the disclosure, the phosphor wheel further comprises a carrier located between the wheel body and the photoluminescence layer and configured to be ring-shaped, wherein each of the blades has a first end and a second end, and the first end is farther from the symmetric center of the wheel body than the second end, wherein an interior edge of a vertical projection of the ring-shaped carrier on the wheel body is closer to symmetric center than a vertical projection of the second end of each of the blades on the wheel body.

In some embodiments of the disclosure, the phosphor wheel further comprises a carrier located between the wheel body and the photoluminescence layer, wherein the wheel body and the carrier comprise the same material.

In some embodiments of the disclosure, the phosphor wheel further comprises a carrier located between the wheel body and the photoluminescence layer, wherein the wheel body and the carrier comprise different materials.

In some embodiments of the disclosure, the photoluminescence layer is configured to be ring-shaped, and an outer edge of the ring-shaped photoluminescence layer is separated from the edge of the wheel body.

In some embodiments of the disclosure, each of the blades has a first end and a second end, the first end is farther from the symmetric center of the wheel body than the second end, and the first end extends to the edge of the wheel body.

In some embodiments of the disclosure, a total area of the blades is from 6,000 mm² to 32,000 mm².

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic perspective view of the phosphor wheel according to the first embodiment of the present disclosure;

FIG. 1B is a schematic perspective view of the phosphor wheel in FIG. 1A, wherein the view angle of FIG. 1A is opposite to FIG. 1B;

FIG. 1C is a schematic cross-sectional view of the phosphor wheel taken along the line 1C-1C′ in FIG. 1A;

FIG. 1D is a schematic back view of the phosphor wheel of FIG. 1A;

FIG. 2A is a schematic perspective view of the phosphor wheel according to the second embodiment of the present disclosure, wherein the view angle of FIG. 2A is the same as FIG. 1A; and

FIG. 2B is a schematic cross-sectional view of the phosphor wheel taken along the line 2B-2B′ in FIG. 2A.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the present disclosure. In other instances, well-known semiconductor processes and manufacturing techniques have not been described in particular detail in order to not unnecessarily obscure the present disclosure. Reference throughout this specification to “one embodiment,” “an embodiment”, “some embodiments” or the like means that a particular feature, structure, configuration, or characteristic described in connection with the embodiment is included in at least one embodiment of the disclosure. Thus, the appearances of the phrase “in one embodiment,” “in an embodiment”, “in some embodiments” or the like in various places throughout this specification are not necessarily referring to the same embodiment of the disclosure. Furthermore, the particular features, structures, configurations, or characteristics may be combined in any suitable manner in one or more embodiments.

The terms “over,” “to,” “between” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

In the present disclosure, a plurality of blades are disposed on a back surface of a wheel body of a phosphor wheel in order to increase the heat dissipation efficiency of the phosphor wheel, wherein the blades are configured to extend along curved paths so as to increase the length and the heat-transfer areas thereof. Moreover, the blades can be located within some areas of the back surface of the wheel body to avoid occupying the whole areas of the back surface of the wheel body in case the air resistance of the blades is high and the phosphor wheel is overweight. Therefore, when a motor is used to drive the phosphor wheel to rotate to disperse heat, the phosphor wheel tends to rotate at high speed, thereby dispersing heat steadily.

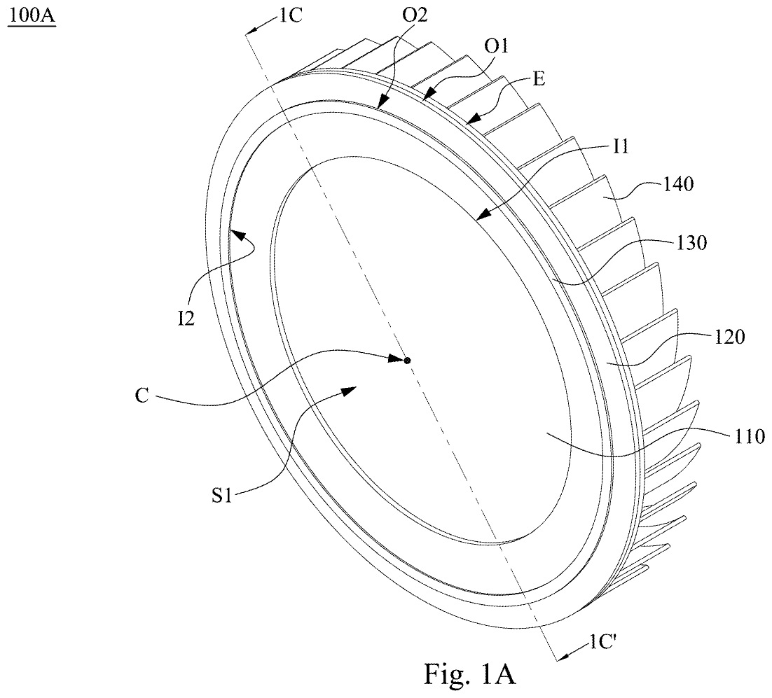

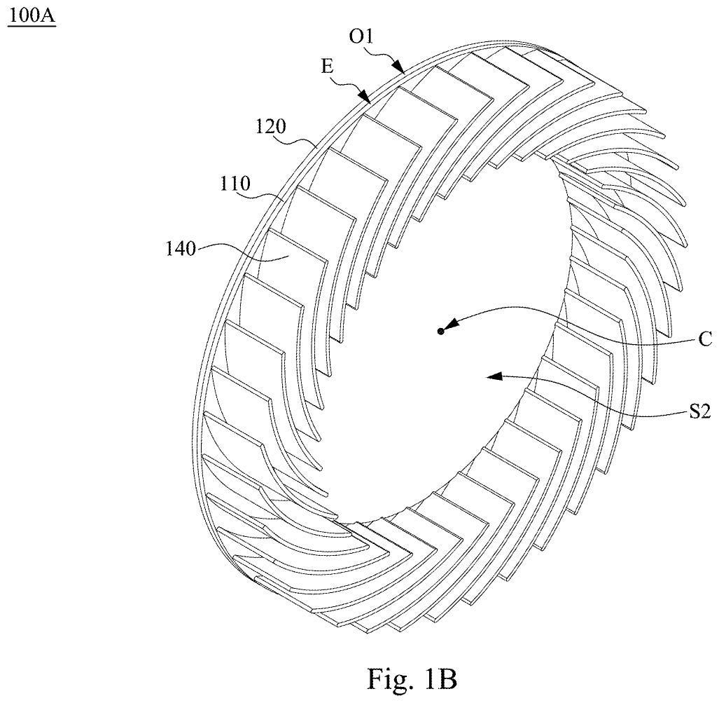

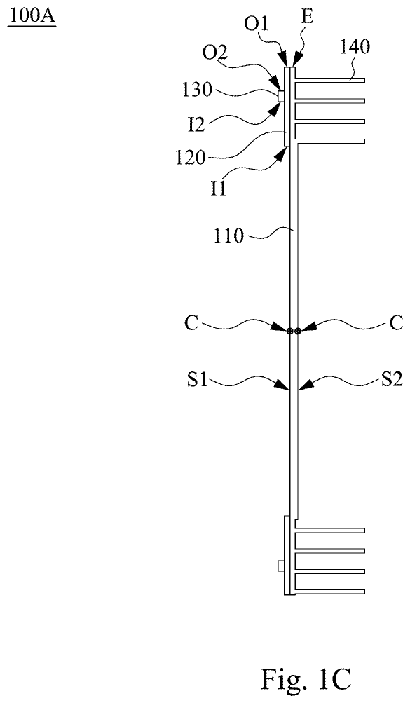

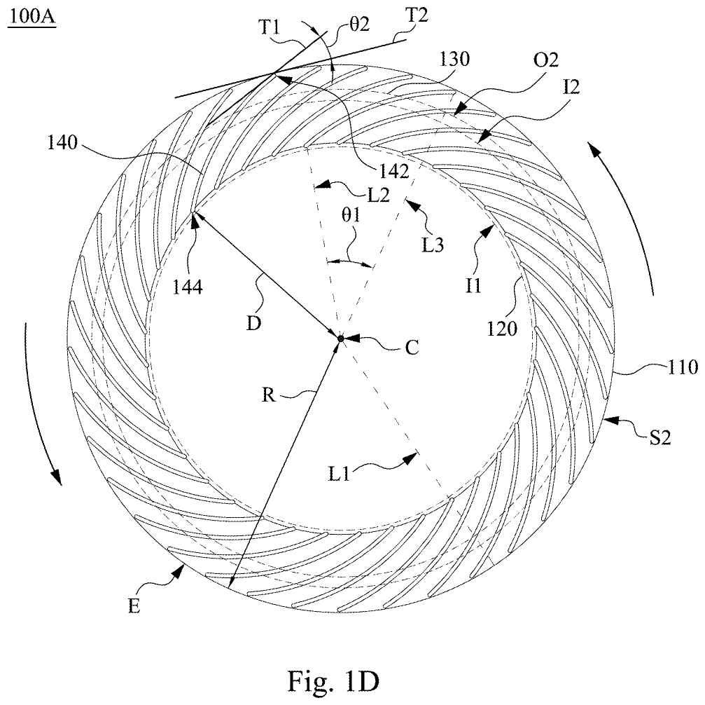

Reference is made to FIG. 1A, FIG. 1B, and FIG. 1C. FIG. 1A is a schematic perspective view of the phosphor wheel 100A according to the first embodiment of the present disclosure. FIG. 1B is a schematic perspective view of the phosphor wheel 100A in FIG. 1A, wherein the view angle of FIG. 1A is opposite to FIG. 1B. FIG. 1C is a schematic sectional view of the phosphor wheel 100A taken along the line 1C-1C′ in FIG. 1A.

Phosphor wheel 100A, which may be a reflective phosphor wheel, can be activated by a light beam, such as a laser beam, to emit light. Moreover, the Phosphor wheel 100A can be connected to a motor (not shown) through a driving shaft (not shown). When the motor drives the driving shaft to rotate, the phosphor wheel 100A rotates together. A phosphor wheel 100A includes a wheel body 110, a carrier 120, a photoluminescence layer 130, and a plurality of blades 140.

The wheel body 110, which is in disc-shape, includes a front surface S1 and a corresponding back surface S2. The disc-shaped wheel body 110 has a circular symmetric appearance, and the wheel body 110 includes a symmetric center C and an edge E. The whole outline of the edge E is radially symmetrical according to the symmetric center C. For the subsequent clarifications, the front surface S1 and the back surface S2 of the wheel body 110 are respectively marked with the symmetric center C. The wheel body 110 can include metal, such as copper, aluminum, or other suitable metal materials. In some embodiments, the driving shaft connected to the motor may be directly or indirectly connected to the wheel body 110, and the driving shaft covers the symmetric center C of the wheel body 110 so that the driving shaft intersects the symmetric center C of the wheel 110.

The carrier 120 and the photoluminescence layer 130 are disposed on the front surface S1 of the wheel body 110, wherein the carrier 120 is located between the wheel body 110 and the photoluminescence layer 130. The carrier 120 and the photoluminescence layer 130 are configured to be in ring-shape and be located within some areas of the front surface S1 of the wheel body 110. Furthermore, the ring-shaped carrier 120 includes an interior edge I1, which surrounds the symmetric center C of the wheel body 110, separated from the symmetric center C by a distance. Moreover, in some embodiments, the ring-shaped carrier 120 includes an outer edge O1, and the outer edge O1 is aligned with the edge E of the wheel body 110.

The areas of the photoluminescence layer 130 are smaller than the areas of the carrier 120. Specifically, an interior edge I2 and an outer edge O2 of the photoluminescence layer 130 is located between the interior edge I1 and the outer edge O1 of the carrier 120. The interior edge I2 and the outer edge O2 are respectively separated with the interior edge I1 and the outer edge O1 of the carrier 120 by a distance.

In some embodiments, the photoluminescence layer 130 can be formed on the carrier 120. For instance, the photoluminescence layer 130 is coated on the carrier 120. Moreover, the carrier 120 can be attached to the front surface S1 of the wheel body 110. For instance, the carrier 120 is attached to the front surface S1 through a colloid layer which is located between the carrier 120 and the wheel body 110. In some embodiments, the photoluminescence layer 130 includes phosphor materials like garnet phosphor powder, such as YAG, TAG, and LuAG phosphor powder, Silicate Phosphor Powder, Nitride Phosphor Powder, or a combination thereof. In some embodiments, the wheel body 110 and the carrier 120 include different materials. For example, the carrier 120 can be a sapphire substrate, a glass substrate, a borosilicate glass substrate, a floated borosilicate glass substrate, a fused quartz substrate, a calcium fluoride substrate, a ceramic substrate, or a combination thereof. However, the carrier 120 of the present disclosure is not limited to the above materials, and the materials of the carrier 120 can be adjusted according to the heat dissipation requirements of manufacturing processes. In some other embodiments, the carrier 120 and the wheel body 110 may also include the same material, that is, both of them may include metal.

The blades 140 disposed on the back surface S2 of the wheel body 110 can form overlapping areas with the carrier 120 and the photoluminescence layer 130. Specifically, the vertical projection of the photoluminescence layer 130 on the wheel body 110 at least partially overlaps the vertical projections of the blades 140 on the wheel body 110.

Based on such configuration, when a light beam is provided to the photoluminescence layer 130 of the phosphor wheel 100A, the photoluminescence layer 130 is activated to emit light. Heat accumulated in the photoluminescence layer 130 can be conducted to the blades 140 through the carrier 120 and the wheel body 110 so that the heat is dispersed through the blades 140 to transfer heat to an outside environment, thereby preventing the photoluminescence layer 130 from accumulating excessive heat. In some embodiments, the blades 140 may include metal, such as copper, aluminum, or other suitable metal materials, wherein the blades 140 and the wheel body 110 are formed integrally. Alternatively, the blades 140 adhere to the wheel body 110.

In this embodiment, the heat dissipation efficiency of the photoluminescence layer 130 can be improved by the configuration of the blades 140. Please refer to the following description. Reference is made to FIG. 1D. FIG. 1D is a schematic back view of the phosphor wheel 100A of FIG. 1A. In order to clarify, the vertical projection of the interior edge I1 of the carrier 120 on the wheel body 110 and the vertical projections of the interior edge I2 and the outer edge O2 of the photoluminescence layer 130 on the wheel body 110 are shown in dotted lines.

Blades 140 are disposed on some areas of the back surface S2 of the wheel body 110. Furthermore, each of the blades 140 includes a first end 142 and a second end 144, wherein the first end 142 is farther from the symmetric center C of the wheel body 110 than the corresponding second end 144, and the second end 144 is separated from the symmetric center C of the wheel body 110 by a distance. For instance, a distance D from one of the second ends 144 of the blades 140 to the symmetric center C of the wheel body 110 is longer than half of the radius R of the wheel body 110. Such configuration can reduce the air resistance of the blades 140, thereby decreasing resistance of the rotating phosphor wheel 100A.

Moreover, compared with each of the second end 144 of the blades 140, the vertical projection of the interior edge I1 of the carrier 120 on the wheel body 110 is closer to the symmetric center C of the wheel body 110, thereby increasing heat-transfer areas from the carrier 120 to the wheel body 110. However, the present disclosure is not limited thereby. In some other embodiments, the interior edge I1 of the carrier 120 can be adjusted based on the requirements of the weight of the phosphor wheel 100A so that the vertical projection of the interior edge I1 of the carrier 120 on the wheel body 110 is aligned with the vertical projection of the second end 144 of each of the blades 140 on the wheel body 110.

The blades 140 respectively extend along curved paths, and the blades 140 are also in curved shape. The mentioned “extend along curved paths” means there are tangent lines with different directions from the first end 142 to the second end 144 about each of the blades 140. Since the blades 140 are configured to be in curved shape, it is beneficial to increase the configuration density and the heat-transfer areas.

In the aspect of increasing configuration density of the blades 140, the blades 140 respectively extend along curved paths so that more than one blade 140 will be disposed on the back surface S2 in any radial direction of the back surface S2 of the wheel body 110, thereby increasing the number of the blades 140 per unit area of the back surface S2 of the wheel body 110. Hereof, the mentioned “more than one blade 140 will be disposed on the back surface S2 in any radial direction of the back surface S2 of the wheel body 110” means: a straight line connecting from the symmetric center C of the wheel body 110 to the edge E of the wheel body intersects two or more blades. For instance, a straight line L1 intersects four of the blades 140.

In the aspect of increasing heat-transfer areas of the blades 140, there is a directive correlation between the heat-transfer areas and the extending length of the blades 140. Therefore, while the blades 140 respectively extend along curved paths, the blades 140 acquire more space to extend longer and more heat-transfer areas. Specifically, for each of the blades 140, one line L2 connecting from the symmetric center C of the wheel body 110 to the second end 144 and one line L3 connecting from the symmetric center C of the wheel body 110 to the corresponding first end 142 form an angle, and the angle is from 20 degrees to 45 degrees.

According to the above mentioned configurations, configuration density and heat-transfer areas of the blades 140 can increase so that the heat dissipation efficiency of the photoluminescence layer 130 also rises. Meanwhile, the blades 140 are located within some areas of the back surface S2 of the wheel body 110 so that the air resistance of the blades 140 decreases. Accordingly, the threshold about rotating the phosphor wheel 100A at high speed can further reduce. That is, a motor outputs lower power to drive the phosphor wheel 100A to rotate at high speed so as to stably disperse the heat in the photoluminescence layer 130.

Moreover, the curvature of the blades 140, which respectively extend along the curved paths, is also related to the air resistance thereof. In some embodiments, the curvature of each of the blades 140 can be defined by a tangent line of a curved path passing through the first end 142 of the corresponding blades 140 and a tangent line of the edge E of the wheel body 110 passing through the same first end 142. Specifically, in FIG. 1D, a tangent line T1 of a curved path can be drawn to pass through the first end 142 of the corresponding blade 140, wherein the tangent line T1 can intersect the edge E of the wheel body 110 at one point. Next, a tangent line T2 of the edge E of the wheel body 100 is drawn to pass through such point so that the tangent line T1 intersects the tangent line T2, and an angle formed by the tangent line T1 and the tangent line T2 is smaller than 45 degrees so as to prevent the blades 140 from causing high air resistance. For instance, while the phosphor wheel 100A shown in FIG. 1D rotates counterclockwise, the angle smaller than 45 degrees so prevents the blades from causing high air resistance.

In another aspect, the blades 140 disposed on the back surface S2 of the wheel body 110 can be adjusted. For instance, in the present embodiment, the blades 140 can extend to touch the edge E of the wheel body 110 at the corresponding first ends 142. However, the present disclosure is not limited thereto. The blades 140 can extend less and the corresponding first ends 142 are close to the edge E of the wheel body 110 but not in aligned with the edge E. That is, the vertical projection of the first end 142 of each of the blades on the wheel body 120 doesn't interacts the vertical projection of the edge E of the wheel body 110.

In some embodiments, the total area of the blades 140 is from 6,000 mm² to 32,000 mm², and the total area can be adjusted according to the operational requirements. For instance, the total area of the blades 140 can be adjusted according to the output power of a laser light source. In some embodiments, while a laser light source emitting light toward the phosphor wheel 100A is 400 watts, the total minimum area of the blades 140 is about 6,000 mm²; while a laser light source emitting light toward the phosphor wheel 100A is 500 watts, the total minimum area of the blades 140 is about 9,000 mm²; while a laser light source emitting light toward the phosphor wheel 100A is 600 watts, the total minimum area of the blades 140 is about 12,000 mm²; while a laser light source emitting light toward the phosphor wheel 100A is 700 watts, the total minimum area of the blades 140 is about 17,000 mm²; while a laser light source emitting light toward the phosphor wheel 100A is 800 watts, the total minimum area of the blades 140 is about 22,000 mm²; while a laser light source emitting light toward the phosphor wheel 100A is 900 watts, the total minimum area of the blades 140 is about 27,000 mm²; while a laser light source emitting light toward the phosphor wheel 100A is 1,000 watts, the total minimum area of the blades 140 is about 32,000 mm². In this regard, the total minimum area of the blades 140 may match the output power of the laser light source according to equation (I):

Y≈(−3)*(10⁻⁷)*(X²)+(0.0323)*X+C (I)

The parameter Y is the output power of the laser light source in watts. The parameter X is the total minimum area of the blades 140 in square millimeters. The value C is a constant, which can be a number from 220 to 240. In practical use, the total area of the designed blades 140 may be virtually greater than the calculated parameter X.

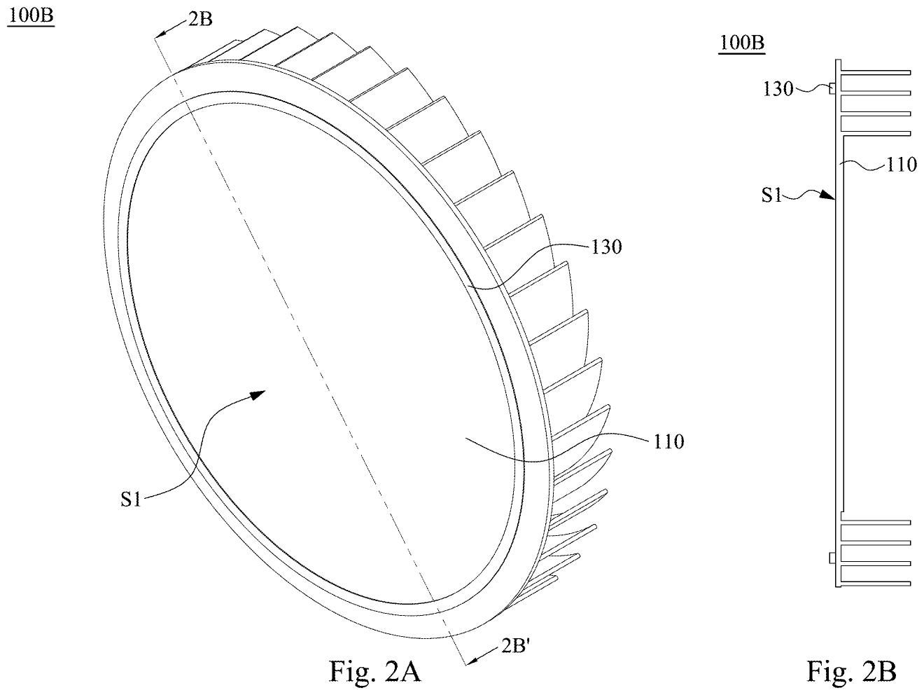

Reference is made to FIG. 2A and FIG. 2B. FIG. 2A is a schematic perspective view of the phosphor wheel 110B according to the second embodiment of the present disclosure, wherein the view angle of FIG. 2A is the same as FIG. 1A. FIG. 2B is a schematic sectional view of the phosphor wheel taken along the line 2B-2B′ in FIG. 2A. The difference between the first embodiment and the present embodiment is that the phosphor wheel 100B excludes the carrier (referring to the carrier 120 shown in FIG. 1A).

Specifically, in the present embodiment, the photoluminescence layer 130 is directly formed on the front surface S1 of the wheel body 110. For instance, it is directly coated on the front surface S1 of the wheel body 110, and the photoluminescence layer 130 is directly in contact with the front surface S1 of the wheel body 110. In other words, a phosphoric material and a metal material form the interface between the photoluminescence layer 130 and the wheel body 110. Based on the configuration, the weight of the phosphor wheel 100B reduces so as to release the load thereof, and the threshold of driving the phosphor wheel 100B to rotate at high speed further decreases.

In summary, the phosphor wheel of the present disclosure includes a wheel body, a photoluminescence layer, and a plurality of blades, wherein the photoluminescence layer and the blades are disposed on the front surface and the back surface of the wheel body. The vertical projection of the photoluminescence layer on the wheel body at least partially overlaps the vertical projections of the blades on the wheel body. The blades are located within some areas of the back surface of the wheel body and respectively extend along curved paths, and a straight line connecting from the symmetric center of the wheel body to the edge of the wheel body intersects more than two blades. Based on the configuration thereof, the blades partially overlap the back surface of the wheel body, and the blades do not occupy the entire area of the back surface of the wheel body so as to avoid high air resistance of the blades and excessive weight of the phosphor wheel. In this way, while a motor drives the phosphor wheel to rotate and disperse heat, the phosphor wheel rotates at high speed easier so that it can stably disperse heat.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A phosphor wheel, comprising:
a wheel body;
a photoluminescence layer disposed on a front surface of the wheel body;
a plurality of blades disposed on a back surface of the wheel body, a vertical projection of the photoluminescence layer on the wheel body at least partially overlapping vertical projections of the blades on the wheel body, wherein the blades are located within some areas of the back surface of the wheel body and respectively extend along curved paths, and any straight line connecting from a symmetric center of the wheel body to an edge of the wheel body intersects more than one of the blades, wherein each of the blades has a first end, a second end, and a convex surface, the first end is farther from the symmetric center than the second end, and a distance from the second end to the symmetric center is longer than half of a radius of the wheel body, wherein one line connecting from the symmetric center of the wheel body to the first end and one line connecting from the symmetric center of the second end form an angle ranging from 20 degrees to 45 degrees, wherein a tangent line of the curved path passing through the first end and a tangent line of the edge of the wheel body passing through the first end form an angle smaller than 45 degrees; and
a motor configured to drive the wheel body to rotate along a rotation direction where the convex surfaces face.

2-3. (canceled)

4. The phosphor wheel of claim 1, further comprising a carrier located between the wheel body and the photoluminescence layer and configured to be ring-shaped, wherein an interior edge of a vertical projection of the ring-shaped carrier on the wheel body is aligned with a vertical projection of the second end of each of the blades on the wheel body.

5. The phosphor wheel of claim 1, further comprising a carrier located between the wheel body and the photoluminescence layer and configured to be ring-shaped, wherein an interior edge of a vertical projection of the ring-shaped carrier on the wheel body is closer to symmetric center than a vertical projection of the second end of each of the blades on the wheel body.

6. The phosphor wheel of claim 1, further comprising a carrier located between the wheel body and the photoluminescence layer, wherein the wheel body and the carrier comprise the same material.

7. The phosphor wheel of claim 1, further comprising a carrier located between the wheel body and the photoluminescence layer, wherein the wheel body and the carrier comprise different materials.

8. The phosphor wheel of claim 1, wherein the photoluminescence layer is configured to be ring-shaped, and an outer edge of the ring-shaped photoluminescence layer is separated from the edge of the wheel body.

9. The phosphor wheel of claim 1, wherein the first end extends to the edge of the wheel body.

10. The phosphor wheel of claim 1, wherein a total area of the blades is from 6,000 mm2 to 32,000 mm2.
